(19) United States
(12) Patent Application Publication
(10) Pub. No.: US 2026/0093663 A1
(43) Pub. Date: Apr. 2, 2026

(54) CHIP AND SYSTEM ARCHITECTURE FOR ACCELERATING NEURAL NETWORK COMPUTATION

(71) Applicant: MOFFETT INTERNATIONAL CO., LIMITED, Kowloon (HK)

(72) Inventors: Changxu ZHANG, Santa Clara, CA (US); Xiaoqian ZHANG, San Jose, CA (US)

(21) Appl. No.: 19/189,016

(22) Filed: Apr. 24, 2025

Related U.S. Application Data
(60) Provisional application No. 63/700,333, filed on Sep. 27, 2024.

(51) Int. Cl. G06F 15/80; G06F 9/48; G06F 15/173

(52) U.S. Cl. CPC G06F 15/80; G06F 9/4881; G06F 15/17375

(57) ABSTRACT

A chip architecture and system design for accelerating neural network computation is disclosed. The chip includes a plurality of cores interconnected via a ring-shaped network-on-chip (NoC), each core comprising a 2D mesh of processing elements (PEs) with hierarchical software-and hardware-based schedulers. Each PE includes specialized compute engines, local memory, and dynamic precision conversion logic. The architecture supports flexible instruction dispatch, scalable memory access, and runtime scheduling optimization. The chip can be deployed in chiplet-based configurations, PCIe cards with paired chips, or modular OAM cards with single-chip packaging. Multi-card systems utilize crossbar switch fabrics and direct inter-card links to enable efficient, low-latency communication and high-bandwidth scalability.

### CROSS-REFERENCE TO RELATED APPLICATION

This application claims the benefit of and priority to U.S. Provisional Patent Application No. 63/700,333, filed on Sep. 27, 2024, the entire contents of which are incorporated herein by reference.

### TECHNICAL FIELD

The present invention relates generally to the field of computer chip architectures and, more particularly, to processor and system architectures for performing neural network computations using arrays of processing elements (PEs) organized in a hierarchical structure with enhanced instruction and data communication mechanisms.

### BACKGROUND

The rapid advancement of artificial intelligence and machine learning has driven the demand for specialized hardware capable of efficiently executing neural network computations. Neural networks typically involve large-scale matrix and tensor operations, vectorized arithmetic, and various data transformation tasks such as transposition and sparsity handling. These workloads require high degrees of parallelism and substantial data and instruction bandwidth to achieve acceptable performance and efficiency.

Conventional chip architectures for neural network processing often organize processing elements (PEs) into regular arrays or tiled structures. While these designs can offer some level of parallelism, they frequently suffer from underutilization of compute resources due to rigid scheduling schemes, inefficient data movement, or inflexible communication topologies. In many cases, PEs are either idle or bottlenecked by limited instruction throughput or memory access contention.

As neural network models grow in complexity and deployment scenarios demand greater energy efficiency, real-time performance, and scalability, there is a critical need for improved chip architectures. These architectures must better utilize the available compute elements, support flexible and efficient instruction/data communication, and enable high-throughput, low-latency execution of diverse neural network operations at scale.

### SUMMARY

A system of one or more computers can be configured to perform particular operations or actions by virtue of having software, firmware, hardware, or a combination thereof installed that, during operation, causes the system to perform those actions. Similarly, one or more computer programs may be configured to perform particular operations by including instructions that, when executed by a data processing apparatus, cause the apparatus to carry out the desired actions.

In one general aspect, a semiconductor device (e.g., a chip) may include a plurality of cores interconnected through a ring-shaped network-on-chip (NoC). Each core may include a plurality of processing entities (PEs), which are themselves connected via a 2D mesh network. Each PE may include (1) a plurality of computing engines, (2) a PE-level software-based instruction scheduler, and (3) a PE-level hardware-based instruction scheduler. The PE-level software-based scheduler is configured to compile incoming instructions and make runtime scheduling decisions for the computing engines based on the compiled instructions. In contrast, the PE-level hardware-based scheduler is configured to execute pre-compiled instructions to directly activate one or more of the computing engines. Other embodiments of this aspect may include corresponding computer systems, apparatuses, and computer programs recorded on one or more computer storage devices, each configured to perform the actions described.

The ring-shaped NoC may be coupled to both a chip-level software-based instruction scheduler and a chip-level hardware-based instruction scheduler. The software-based scheduler compiles incoming instructions and generates scheduled tasks for the cores, while the hardware-based scheduler stores and executes pre-compiled instructions to activate hardware components at the chip level.

The 2D mesh network may be connected to a core-level software-based instruction scheduler and a core-level hardware-based instruction scheduler. The software-based scheduler is responsible for compiling incoming instructions and generating scheduled tasks for the PEs, while the hardware-based scheduler handles pre-compiled instructions to control hardware components within the core.

The PE-level software-based instruction scheduler may include a processor configured to compile incoming instructions and execute them to produce runtime scheduling decisions.

The PE-level hardware-based instruction scheduler may be designed to activate one or more computing engines for executing predefined computation logic.

The software-based scheduler at the PE level may be assigned a higher scheduling priority than its hardware-based counterpart, allowing for greater runtime flexibility and adaptability.

The software-based instruction scheduler may also send control instructions to the hardware-based scheduler to initiate execution on specific computing engines.

The hardware-based scheduler may operate faster than the software-based scheduler when activating the PE's computing engines, offering low-latency execution for time-critical workloads.

Each core may be coupled to a dedicated cache and a corresponding DDR memory. The DDR modules of neighboring cores may be interconnected via the ring-shaped NoC to facilitate cross-core data exchange.

The PEs within each core may be interconnected through a 2D mesh network using a set of routers, with each PE linked to its own router.

Routers may also connect PEs from adjacent cores, enabling inter-core communication and expanding the effective mesh topology beyond a single core.

The plurality of cores may be distributed across multiple dies in a chiplet-based configuration. For example, four cores may be deployed on either two or four dies. In a two-die setup, the dies are linked via a UCIe interface, while a four-die configuration may be arranged in a 2×2 grid, with each die connected to its neighboring dies via respective UCIe interfaces.

Each PE may further include an SRAM, with multiple ports individually connected to the computing engines within the PE to support high-bandwidth memory access.

An instruction distribution unit (IDU) may be included in each core to retrieve instructions from the connected DDR memory. The core-level software-based instruction scheduler may configure the IDU to start or pause instruction fetching based on workload demands.

Each PE may also include a data switch responsible for moving incoming data into the PE's SRAM and performing data format conversion between high-precision and low-precision representations.

The PE's computing engines may include a first engine for tensor computations, a second engine for vector operations, a third engine for tensor transposition, and a fourth engine for sparsification and de-sparsification of tensors.

In some embodiments, the disclosed chip architecture may be deployed on a PCIe card that includes a pair of the described chips, where one chip operates as a primary chip and the other as a secondary chip. The primary chip communicates with a host system via a PCIe interface, while the secondary chip is linked to the primary through high-speed Ethernet channels. Each chip may include its own voltage regulation module (VRM), local DRAM modules, and external communication interfaces. The Ethernet interface of each chip may be logically partitioned into multiple channels to support both intra-card communication and inter-card scalability. This dual-chip PCIe card structure enables efficient task delegation, memory bandwidth sharing, and scalable workload distribution across multiple cards in a system.

In some implementations, multiple PCIe cards may be installed in a host system or across multiple host systems, with inter-card communication achieved via a shared backplane or direct cabling. Cards may be organized into groups, each connected to a host via a PCIe switch, and further interconnected through a backplane fabric that includes crossbar switches. This system-level architecture supports distributed inference or training tasks, coordinated scheduling across cards, and dynamic workload balancing across hosts.

In other embodiments, the chip architecture may be deployed on a modular OAM (OCP Accelerator Module) card, with each OAM card packaging a single chip and including a dedicated VRM, DRAM modules, a PCIe interface, and multiple Ethernet channels. Unlike PCIe cards that require limited motherboard slots, OAM cards are designed to plug directly into a system motherboard or carrier board via OAM sockets, enabling much higher accelerator density. The modularity and direct-plug design of OAM cards simplify system integration and power delivery while improving thermal management.

OAM cards may also be organized into high-density systems, such as racks of 8, 16, or more cards, connected via internal crossbar switching fabrics and one-to-one direct links between cards. This topology enables each OAM card to maintain direct, low-latency connections with a subset of peer cards, facilitating high-throughput, tightly coupled distributed computation. The architecture is highly scalable and suitable for large-scale AI model training, inference, or other compute-intensive tasks requiring efficient inter-card communication and coordinated execution across many accelerator modules.

Implementations of the described techniques may be realized in hardware, as a method or process, or as software recorded on a computer-readable medium.

### BRIEF DESCRIPTION OF THE DRAWINGS

FIG. 1 illustrates an exemplary chip architecture for accelerating neural network computation, in accordance with various embodiments.

FIG. 2 illustrates an exemplary core architecture in the chip for accelerating neural network computation, in accordance with various embodiments.

FIG. 3A illustrates an exemplary PE architecture in the chip for accelerating neural network computation, in accordance with various embodiments.

FIG. 3B illustrates the instruction dispatch unit of the exemplary PE in the chip for accelerating neural network computation, in accordance with various embodiments.

FIG. 4 illustrates an exemplary chiplet implementation of the chip for accelerating neural network computation, in accordance with various embodiments.

FIG. 5 illustrates another exemplary chiplet implementation of the chip for accelerating neural network computation, in accordance with various embodiments.

FIG. 6 illustrate an exemplary PCIe card with a pair of the chips for accelerating neural network computation, in accordance with various embodiments.

FIG. 7 illustrate an exemplary multi-card system with multiple PCIe cards hosting the chips for accelerating neural network computation, in accordance with various embodiments.

FIG. 8 illustrate an exemplary backplane architecture in the multi-card system of FIG. 7, in accordance with various embodiments.

FIG. 9 illustrate an exemplary OAM card hosting the chip for accelerating neural network computation, in accordance with various embodiments.

FIG. 10 illustrate an exemplary multi-card system with multiple OAM cards hosting the chips for accelerating neural network computation, in accordance with various embodiments.

### DETAIL DESCRIPTION OF THE EMBODIMENTS

Embodiments described herein provide a novel chip design and system design for accelerating neural network computation, in particular, tensor computation.

Traditional chip architectures for neural network computation tend to adopt relatively simple, monolithic approaches to processing element (PE) array organization and task scheduling. These designs often rely on a flat hierarchy of compute units, with limited or centralized control logic that cannot flexibly adapt to the dynamic execution requirements of modern deep learning workloads. As a result, compute resources are frequently underutilized—especially in heterogeneous or bursty workloads where different layers or models exhibit widely varying computational patterns.

Many conventional architectures assume uniform workloads and static dataflows, leading to rigid task allocation and bottlenecks in instruction and data distribution. For example, task scheduling is often performed at a single centralized level, without the ability to delegate scheduling decisions hierarchically across chip, core, and PE levels. This leads to latency overhead, insufficient parallelism, and difficulty scaling the architecture efficiently across larger PE arrays or chiplet-based systems.

Moreover, conventional PE designs are typically optimized for a narrow class of operations—such as matrix multiplication or convolution—without the ability to dynamically support operations like data transposition, sparsity encoding/decoding, or activation function processing within the PE itself. In such cases, data must be offloaded to external functional blocks or general-purpose cores, resulting in additional communication cost and pipeline stalls.

These limitations are compounded by simplistic network-on-chip (NoC) topologies that do not prioritize low-latency, high-bandwidth communication across hierarchical levels of the chip. Naively connected PEs or cores using uniform mesh or bus-based interconnects are insufficient to support scalable, efficient data movement across large NPU systems—particularly when inter-core or inter-die communication is required.

In contrast to these simplistic and relatively rigid architectures, the present design introduces a deeply integrated and hierarchical architecture specifically aimed at maximizing PE utilization, instruction/data throughput, and parallel scalability. As described in greater detail below, the chip integrates layered software and hardware schedulers, multi-topology NoC structures, and a flexible PE-level architecture that supports specialized compute engines and dynamic control logic—all working in concert to address the inefficiencies found in traditional approaches.

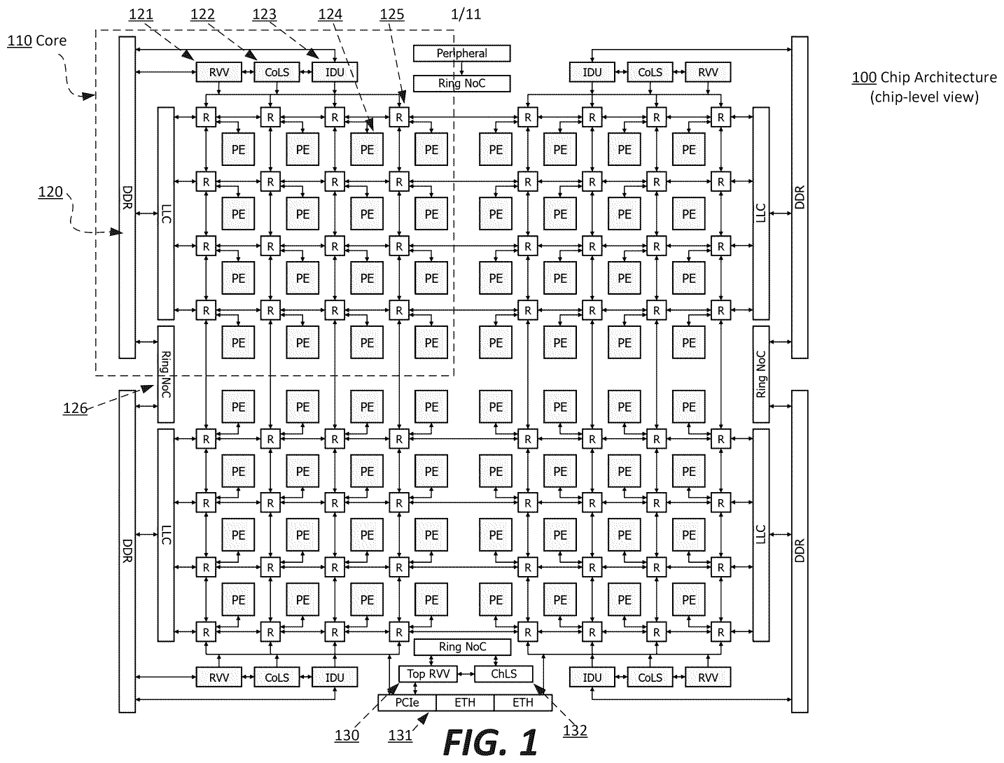

FIG. 1 illustrates an exemplary chip architecture for accelerating neural network computation, in accordance with various embodiments. Referring to FIG. 1, a semiconductor device (e.g., the chip 100) includes a plurality of cores 110 interconnected via a ring-shaped network-on-chip (NoC) 126. In the illustrative embodiment shown, the chip includes four cores 110, although other configurations with more or fewer cores may also be used depending on the implementation. The ring NoC 126 facilitates bidirectional communication among the cores, enabling high-throughput and low-latency data and instruction exchange across the chip.

Each core 110 in chip 100 is associated with a dedicated last-level cache (LLC) and is connected to a corresponding core-specific double data rate (DDR) memory module 120. These memory modules serve as local memory banks that store instructions and data used by the respective cores. In some embodiments, the DDR memory modules 120 of different cores are also connected to one another via the ring NoC 126, allowing for cross-core access. For example, one core may write intermediate results of a neural network computation to its own DDR 120, and another core may subsequently retrieve that data to continue the computation. This design enables distributed memory access across the chip, optimizing data locality and reducing redundant memory transfers.

The chip 100 further includes chip-level communication interfaces 131, which may comprise a PCI Express (PCIe) interface and an Ethernet (ETH) interface. These interfaces allow the chip to communicate with external hosts or other chips, forming part of a larger system or computing board. The PCIe and Ethernet interfaces may support high-bandwidth data exchange, remote instruction dispatching, or control signaling.

To orchestrate computation and manage task scheduling across the cores, the chip 100 integrates a chip-level RISC-V Vector (RVV) processing unit 130 and a chip-level hardware scheduler, i.e., Chip-Level Scheduler (ChLS) 132. The RVV unit 130 may include one or more general-purpose processors or vector processors configured to compile incoming instructions and implement software-based scheduling logic. By leveraging real-time instruction compilation and execution, the RVV unit 130 can dynamically determine task allocation strategies, optimize resource usage across cores, and implement fault-tolerant scheduling policies during runtime.

In contrast, the hardware-based scheduler ChLS 132 may be configured to execute pre-compiled scheduling instructions and manage task dispatch in a hardware-accelerated manner, e.g., distributing the pre-compiled tasks for chip-level hardware components such as the cores and/or the routers connecting the cores. The ChLS 132 bypasses the instruction compilation phase, enabling fast and deterministic task scheduling with low latency. However, the ChLS is typically limited to executing predefined instruction sequences, making it less flexible than the RVV 130 for handling dynamic or irregular workloads.

The dual-scheduler design provides a balance between flexibility and speed. Under various operating conditions, the chip 100 may dynamically switch between software-based scheduling via RVV 130 and hardware-based scheduling via ChLS 132. For example, the RVV 130 may analyze an incoming instruction stream and determine that a particular batch of tasks can be efficiently handled by the ChLS 132, thereby delegating control to the hardware scheduler for faster execution. Conversely, when instructions require real-time compilation or when the workload demands complex task orchestration, the RVV 130 may retain control and schedule tasks directly. This hybrid scheduling architecture offers significant performance advantages over conventional chip designs that rely on a single type of scheduler.

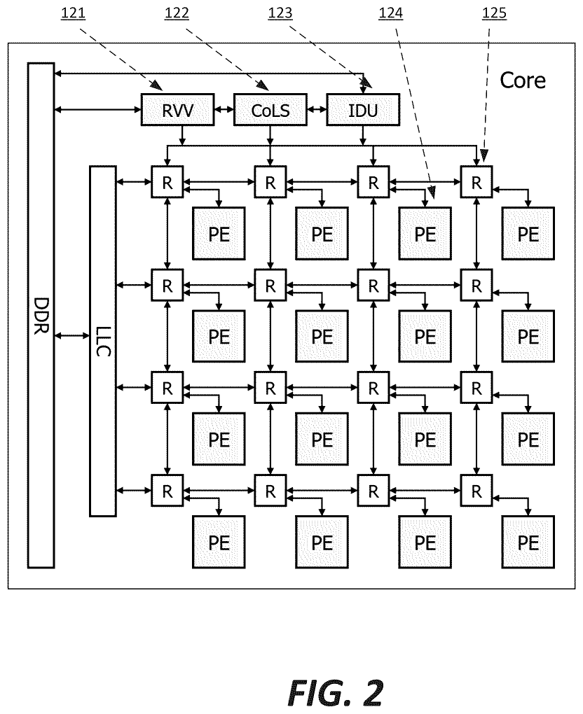

At the core level, each core 110 may receive scheduling directives and/or data from the chip-level schedulers via its DDR memory interface. FIG. 2 illustrates an exemplary core architecture in the chip for accelerating neural network computation, in accordance with various embodiments. Each core 110 further includes its own software-based and hardware-based schedulers—namely, a core-level RVV unit 121 and a core-level scheduler (CoLS) 122.

Additionally, each core comprises an Instruction Dispatch Unit (IDU) 123, configured to fetch instructions from DDR 120 and distribute them to the constituent processing elements (PEs) 124. The core-level schedulers manage intra-core instruction flow, assign tasks to the PEs, and synchronize data movement between memory and compute units.

The core-level RVV unit 121 serves as the software-based instruction scheduler for the core and is configured to compile incoming instructions received from chip-level scheduling logic or external sources. Based on the compiled instructions, the RVV unit 121 generates scheduled tasks for the individual PEs 124, assigning workloads dynamically and making run-time decisions to optimize task distribution, load balancing, and execution order.

In contrast, the CoLS 122 operates as a hardware-based instruction scheduler that executes pre-compiled instruction sequences. These pre-compiled (i.e., already compiled) instructions may be previously stored in local memory or preloaded during initialization and are used to activate specific hardware components within the core (i.e., the core-level hardware components)—such as the PEs or communication fabric—without requiring real-time compilation or scheduling logic. This enables the CoLS 122 to provide fast and deterministic task scheduling with minimal overhead, particularly for common or repetitive compute patterns.

As shown in both FIG. 1 and FIG. 2, each core includes a plurality of PEs 124 organized as a 2D mesh and interconnected through a corresponding network of routers 125. This 2D mesh topology allows for scalable communication among the PEs, enabling parallel execution of neural network operations with minimized data movement overhead. The mesh structure supports localized communication for most operations, while the ring NoC at the chip level ensures efficient global coordination among the cores.

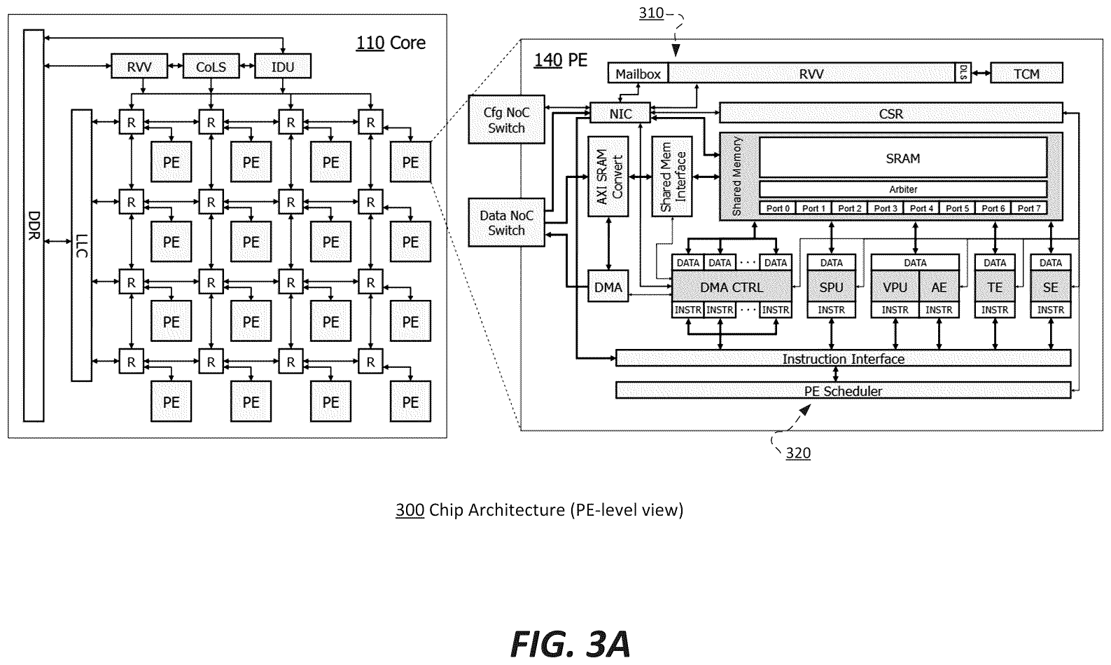

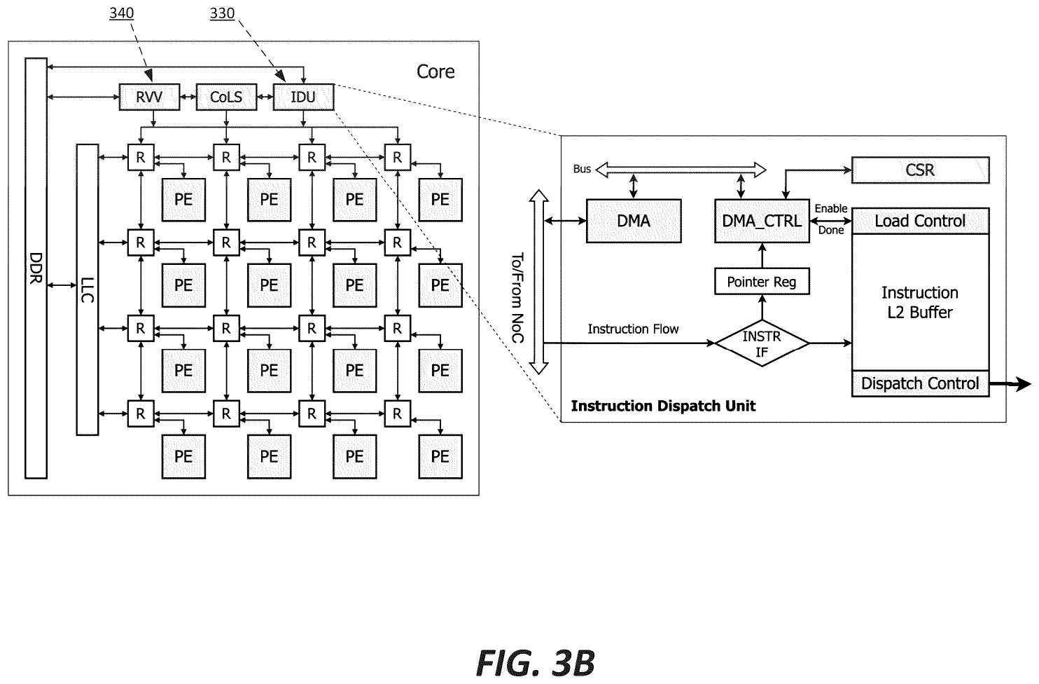

FIG. 3A illustrates an exemplary PE architecture in the chip for accelerating neural network computation, in accordance with various embodiments. As described above, each core 110 includes a plurality of Processing Entities (PEs) 140 arranged in a 2D mesh network and interconnected via a corresponding network of routers. In some embodiments, each PE 140 has a dedicated router that links the PE to its neighboring PEs (within the same core or across a different core), enabling direct, low-latency communication paths for data sharing and coordination during parallel computation.

In configurations where neighboring cores are physically adjacent (e.g., each core has two neighboring cores in a two-by-two configuration as shown in FIG. 1), the routers of the edge PEs in one core are connected to the routers of the adjacent edge PEs in a second core, enabling inter-core communication without requiring a centralized hub. On the opposite side, the routers of PEs are connected to the core's last-level cache (LLC), which serves as an intermediary buffer between the PEs and the core-specific DDR memory 120. During memory operations, data requested by a PE is first retrieved from the DDR into the LLC and then propagated to the corresponding PE through the router network. Similarly, when PEs generate data, such as intermediate or final computation results, the data is transmitted to the LLC via the router network, and subsequently written into the DDR under the control of cache management logic.

Zooming in to the architecture of an individual PE 140, each PE140 includes a PE-level software-based instruction scheduler implemented as an RVV 310, a PE-level hardware-based instruction scheduler (labeled as the PE scheduler 320 in FIG. 3A), a plurality of specialized computing engines, and a local SRAM. The computing engines are optimized for various neural network operations and include, in one embodiment, a Direct Memory Access controller (DMA Ctrl), a Sparse Processing Unit (SPU), a Vector Processing Unit (VPU), an Activation Engine (AE), a Transpose Engine (TE), and a Sorting Engine (SE).

Each of the computing engines within the PE is configured to perform a specific class of operations. For example, the DMA Ctrl engine manages high-speed data movement between the PE and memory (e.g., the LLC, the DDR) without the involvement of another processor; the SPU performs sparse tensor multiplications and related sparse-aware computations; the VPU handles standard vectorized arithmetic operations such as additions, multiplications, and fused operations; the AE applies activation functions like ReLU, Sigmoid, and Softmax; the TE performs tensor dimension reordering and transposition tasks; and the Sorting Engine executes sorting functions useful for pruning, attention mechanisms, or identifying top-k elements in sparse data contexts.

Each computing engine includes an instruction interface for receiving task instructions from either the PE-level software-based scheduler (i.e., the PE-level RVV 310) or the hardware scheduler (i.e., the PE scheduler 320). These instructions may trigger individual or chained execution sequences across multiple engines. After executing a task, an engine may send control signals or flags back to the PE scheduler to activate the next engine, or to the RVV 310 for further scheduling based on the result of the completed task, or to the PE scheduler 320 to directly activate another computing engine to execute subsequent computation. For instance, after completing a sorting operation, the SE may trigger the SPU—via the PE scheduler or RVV —to begin matrix sparsification on the sorted data (e.g., pruning out tensor values that are below a threshold value).

In addition, each of the plurality of computing engines includes a data interface that is coupled to a corresponding port of the local SRAM, allowing fast read/write access to input operands and output results. This direct connections ensure high bandwidth and low latency between the compute logic and memory storage, enabling parallel processing (through parallel data accessing) among the engines.

The PE 140 also includes a configuration NoC switch and a data NoC switch. The data NoC switch is configured to (1) receive incoming data from the NoC (e.g., from the LLC or the DDR) and load the data into the PE's SRAM and (2) perform format conversion between high-precision and low-precision representations, such as float32-to-int8 or vice versa. The format conversion is particularly important in neural network computation, where different stages of the model may operate at varying precision levels to optimize memory bandwidth, computational throughput, and power efficiency. For example, training or sensitive inference stages may require 16-bit or 32-bit floating-point precision, while certain matrix multiplications or activation operations may tolerate or even benefit from 8-bit or lower integer representations.

In some embodiments, to support these diverse precision requirements, the data NoC switch may include logic for transforming the bit-depth of tensor elements as they enter or exit the PE. This may involve bit-depth expansion, where incoming low-precision data is converted into higher-precision format (e.g., int8 to float32) before being written into the PE's SRAM; or bit-depth compression, where outgoing high-precision data is compacted into a lower bit-depth format to reduce memory footprint or communication overhead.

These conversion processes are used to align data with the minimum granularity and bit-width requirements of the PE's internal memory architecture, ensuring efficient use of the shared memory's bandwidth. In practice, the format conversion may be implemented using a combination of lookup tables and configurable logic that map tensor values between different numerical representations. Additionally, dimension-level adjustments, such as padding or de-padding of tensor shapes, may be performed to match the memory bank structure or processing width of vector engines inside the PE. By integrating precision-aware conversion into the data ingress and egress pathways of each PE, the architecture enables seamless interoperability between compute units operating at different precision levels, reduces the need for external format adaptation logic, and allows flexible deployment of quantized neural network models on the same hardware fabric.

Referring back to the PE architecture, the configuration NoC switch may be responsible for receiving setup and control instructions. These configuration instructions are used to update the contents of a control and status register (CSR), which stores execution state, engine configuration parameters, and runtime flags used for dynamic task management.

To support synchronization across PEs, each PE further comprises a mailbox interface. The mailbox enables the exchange of control messages between the RVV 310 with other PEs across the chip and allows for fine-grained inter-PE coordination during execution of large-scale neural network workloads.

As shown in FIG. 3A, there are two primary modes of scheduling within each PE 140: (1) a software-based approach (using the RVV 310) and (2) a hardware-based approach (using the PE scheduler 320). In the software-based approach, the RVV 310 serves as a local instruction processor responsible for compiling incoming instructions and making real-time scheduling decisions for the PE's computing engines. The RVV 310 may be implemented as a single-core vector processor optimized for neural network workloads. It is coupled with a Tightly Coupled Memory (TCM), which is a low-latency scratchpad memory directly connected to the RVV for storing critical instruction data and intermediate results.

In the hardware-based approach, the PE scheduler 320 executes pre-compiled instruction sequences to directly activate the computing engines without the need for runtime instruction compilation. This mechanism offers faster activation and lower latency compared to software-based scheduling but is limited to fixed-function logic preloaded in hardware. Although the RVV-based scheduler introduces higher latency due to the overhead of compilation and control logic, it is more flexible and capable of implementing custom execution policies, making it well-suited for dynamic and heterogeneous workloads.

To optimize overall execution, the software-based RVV 310 scheduler may be assigned a higher scheduling priority than the hardware scheduler 320 to support flexible runtime adaptability. In certain scenarios, the RVV 310 may also delegate control to the PE scheduler to execute pre-compiled instructions, achieving faster task activation. In this way, the PE 140 can seamlessly alternate between flexibility and speed based on the characteristics of the workload.

FIG. 3B illustrates the instruction dispatch unit (IDU) 330 of the exemplary PE in the chip for accelerating neural network computation, in accordance with various embodiments. As described above with respect to FIGS. 1 and 2, each core 110 includes a dedicated IDU that is responsible for fetching instructions from its corresponding DDR 120 and distributing them to the PEs 124 within the core. The IDU 330 operates as an intermediary between core-level instruction memory and the PE-level execution fabric, ensuring that each PE receives the appropriate instructions in a timely and organized manner to sustain efficient parallel processing.

In some embodiments, the IDU 330 is configured and controlled by the core-level RVV 340, which serves as the core's software-based instruction scheduler. For instance, during initialization or runtime scheduling, the RVV 340 may issue a control signal to the IDU 330 to start or pause instruction retrieval from the DDR. This control may include providing an instruction queue pointer to the IDU 330, which is then used to identify the address or location in DDR from which to begin fetching instructions. The fetched instructions are organized by the IDU 330 as a linked list, with each new instruction appended to the end of the queue. This structure supports dynamic instruction sequencing and prefetching, allowing for flexible adaptation to workload dependencies and execution order.

To improve throughput and reduce idle time among the PEs, the IDU 330 may implement a prefetching mechanism to retrieve instructions ahead of time based on instruction dependencies or anticipated compute cycles. Fetched instructions are loaded from the DDR into a local instruction L2 buffer via DMA transfer. The L2 buffer acts as an intermediate cache that decouples the latency of DDR access from the timing of instruction delivery to the PEs. Once instructions are stored in the L2 buffer, the IDU 330 distributes them to the SRAMs of individual PEs according to the runtime decisions made by the core-level RVV 340.

In some embodiments, the IDU 330 is configured with a defined instruction-fetching flow controlled by buffer thresholds. For example, if the L2 buffer reaches a threshold level of occupancy—indicating it is nearly full—the IDU 330 may pause instruction retrieval from the DDR to avoid overflow. Conversely, when the SRAMs of the PEs are nearing depletion (e.g., below a predetermined threshold), the IDU 330 resumes distribution of instructions from the L2 buffer into the PE-level SRAMs. This flow-control mechanism ensures continuous instruction delivery without stalling the compute pipeline, balancing the latency of instruction fetching with the throughput needs of distributed execution.

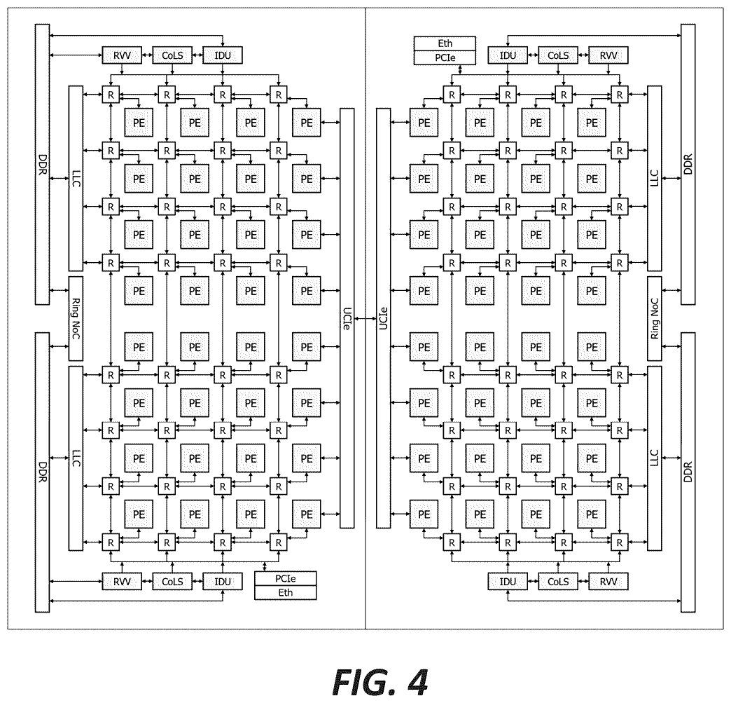

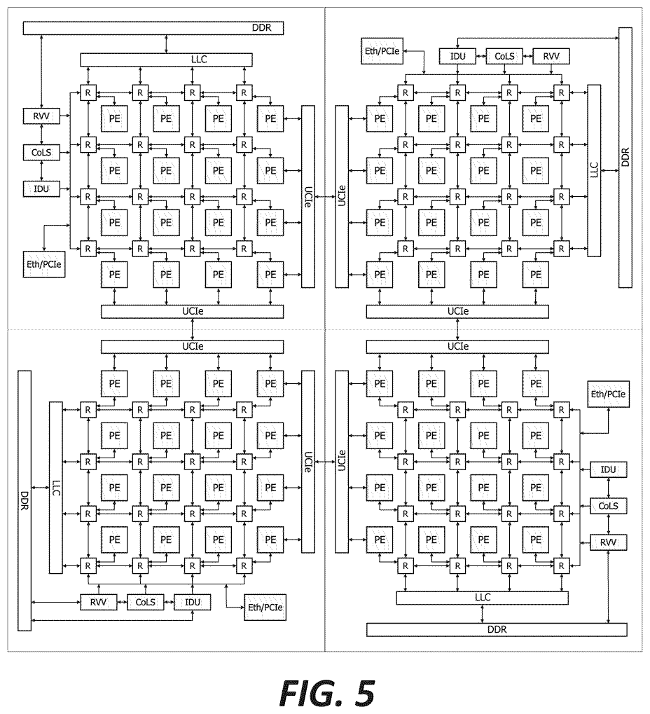

FIGS. 4 and 5 illustrate two exemplary chiplet implementations of the chip for accelerating neural network computation, in accordance with various embodiments. These implementations demonstrate how the chip architecture described in FIG. 1—which includes four interconnected cores—can be physically partitioned across multiple semiconductor dies using a chiplet-based design. This modular approach enables improved scalability, manufacturing flexibility, and interconnect optimization.

FIG. 4 shows a two-die implementation of the four-core chip. In this embodiment, each die hosts two of the four cores 110, and the two dies are connected via respective Universal Chiplet Interconnect Express (UCIe) interfaces. The PEs located at the edges of the two adjacent dies are connected through these UCIe interfaces, enabling low-latency, high-bandwidth communication between neighboring PEs across dies. This preserves the logical continuity of the mesh and ring NoC architectures described earlier while physically distributing the compute fabric across two substrates.

Each die in FIG. 4 further includes its own die-level communication interface—for example, a PCIe interface and an Ethernet interface—which allows it to connect to external hosts or other chips. Within each die, only one of the two cores is equipped with the die interface logic, simplifying layout and reducing die area overhead. The die-level interfaces can support system-level integration for multi-chip modules, board-level interconnection, or host-managed data orchestration.

In practical implementations, to reduce wire crossing and improve layout cleanliness, the two cores on one side of the layout (e.g., the right-hand side of FIG. 4) may be rotated by 180 degrees. This orientation aligns routing paths between neighboring cores or dies and reduces the complexity of inter-die signaling, especially for the shared NoC or memory lines.

FIG. 5 illustrates an alternative four-die implementation of the same four-core chip, where each die hosts a single core 110. In this embodiment, the four dies are arranged in a two-by-two grid. Each die is adjacent to two neighboring dies and includes two UCIe interfaces for inter-die communication. Similar to FIG. 4, the edge PEs of neighboring dies are interconnected through UCIe interfaces, preserving the logical continuity of the PE mesh and supporting the scalable execution of neural network computations across die boundaries.

In contrast to the asymmetric interface distribution in FIG. 4, each of the four dies in FIG. 5 includes a complete die-level interface, such as PCIe and Ethernet, for communication with other chips or a host system. This uniform configuration allows each die to function independently or as part of a larger compute array, providing flexibility for system integrators.

To further simplify interconnect routing and optimize the physical design, each core in the four-die implementation of FIG. 5 may be rotated by 90 degrees relative to the orientation shown in FIG. 1. This rotation facilitates direct, clean wiring between adjacent dies while preserving the symmetry and topology of the 2D mesh and ring NoC fabrics.

These chiplet implementations demonstrate how the scalable architecture described herein can be adapted to different physical layouts while maintaining consistent logical structures, efficient PE-to-PE communication, and flexible system-level integration across a wide range of packaging and deployment scenarios.

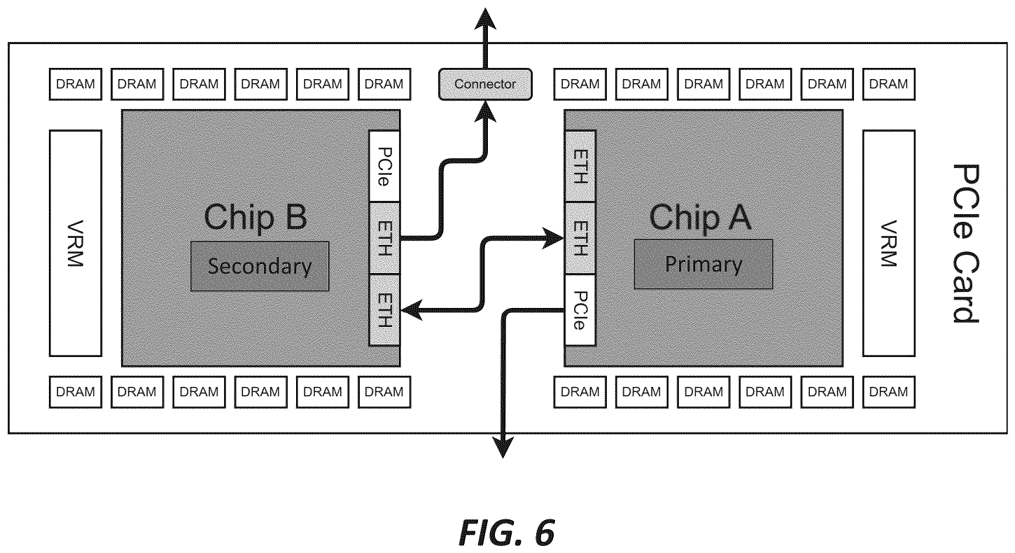

FIG. 6 illustrate an exemplary PCIe card with a pair of the chips for accelerating neural network computation, in accordance with various embodiments. The PCIe card includes two chips—referred to herein as Chip A and Chip B—each of which may implement the chip architecture described with respect to FIGS. 1 through 5. That is, each chip includes a plurality of compute cores, each core comprising a 2D array of processing elements (PEs), hierarchical software-and hardware-based instruction schedulers, a ring-shaped network-on-chip (NoC), and inter-die UCIe interfaces in chiplet configurations.

Each of Chip A and Chip B includes its own dedicated voltage regulation module (VRM), a local set of DRAM modules for external memory access, and multiple communication interfaces, including PCIe and Ethernet interfaces. These interfaces enable the chips to communicate with host systems, other accelerators, and each other to coordinate compute workloads and manage data flow.

Among the pair of chips on the PCIe card, one chip—Chip A in this example—is designated as the primary chip, while the other chip—Chip B—is designated as the secondary chip. The primary chip's PCIe interface is connected to the host processor or system controller, and is responsible for receiving incoming instructions and data, as well as managing host-device communications. In contrast, the secondary chip's PCIe interface remains idle and is not directly connected to the host in this configuration.

The primary and secondary chips are interconnected via their respective Ethernet interfaces. In particular, each Ethernet interface in each chip is logically divided into multiple independent channels. A first Ethernet channel of the primary chip is connected to a first Ethernet channel of the secondary chip to support direct inter-chip communication for instruction exchange, task delegation, and data sharing. The primary chip may relay a portion of the compute workload to the secondary chip via this Ethernet link, allowing both chips to operate cooperatively on the same neural network workload.

The secondary chip's second Ethernet channel may be configured to connect to an external PCIe card through a physical board-to-board connector or edge connector. This allows the system to daisy-chain multiple accelerator cards for greater compute scalability. The second Ethernet channel of the primary chip may remain idle in this configuration, but could alternatively be activated to support multi-host or multi-card interconnects, depending on system deployment needs.

In some embodiments, idle interfaces on either chip—such as unused PCIe or Ethernet ports—may be flexibly reconfigured to support additional PCIe cards, hosts, or external accelerators. This modular interface configuration allows system designers to scale performance by adding more compute cards without requiring substantial rearchitecting of the communication protocol or scheduling logic. The combination of primary and secondary chip roles, along with dynamic use of multi-channel Ethernet interconnects, supports efficient workload partitioning, high-throughput data routing, and distributed parallel execution across multiple chips or accelerator boards.

In some embodiments, the primary and secondary chip roles may be dynamically reassigned based on system conditions or deployment requirements. For example, in the event of a failure or degraded performance in the primary chip's PCIe interface, the secondary chip may be promoted to act as the new primary. This failover capability enhances system robustness by allowing the card to maintain host connectivity and continue processing workloads with minimal disruption. Additionally, in configurations involving multiple PCIe cards connected via Ethernet or other high-speed interconnects, different chips on different cards may assume the primary role depending on the topology, workload distribution strategy, or proximity to the host.

As shown, the configuration illustrated in FIG. 6 is highly scalable, making it particularly well-suited for large-scale artificial intelligence (AI) and deep learning workloads that require extensive parallel processing and memory bandwidth. By connecting multiple PCIe cards—each with a pair of tightly coupled computing chips—via high-speed Ethernet links or other board-level interconnects, system designers can construct a compute cluster capable of running massive neural network models, training deep learning architectures with large datasets, or performing distributed inference across multiple nodes. The modular chiplet architecture within each chip, combined with inter-chip and inter-card expandability, allows the system to scale both horizontally (by adding more cards) and vertically (by integrating higher-density cores within each chip) while preserving performance, latency, and workload balance across the fabric.

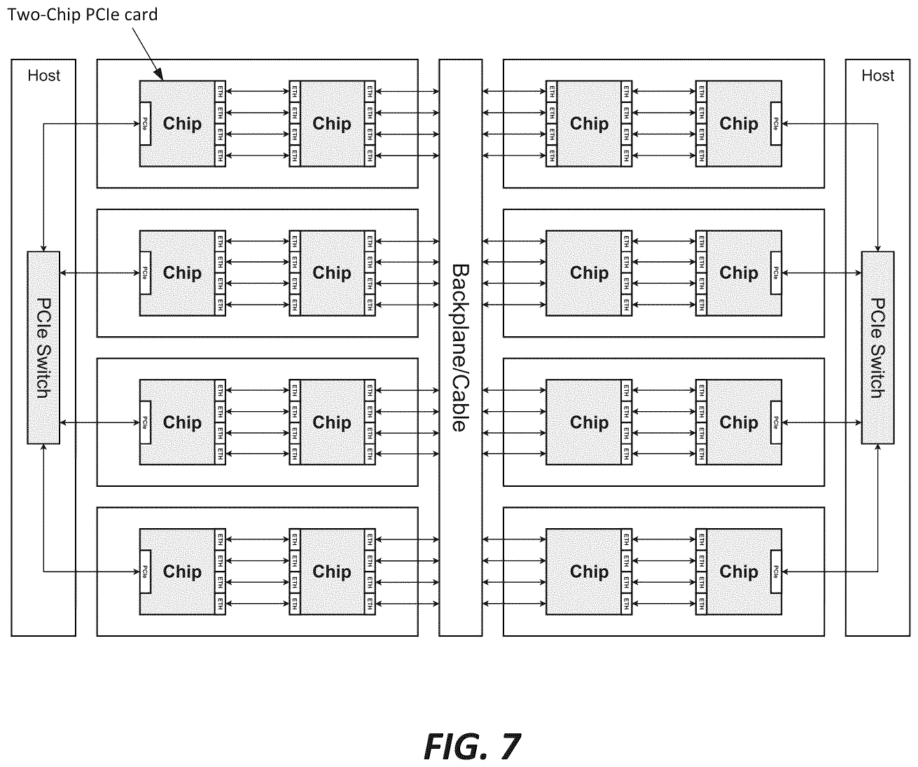

FIG. 7 illustrate an exemplary multi-card system with multiple PCIe cards hosting the chips for accelerating neural network computation, in accordance with various embodiments. This figure expands on the architecture introduced in FIG. 6, demonstrating how the two-chip PCIe card design can be scaled into a high-performance, multi-board compute system suitable for large-scale AI workloads.

As shown in FIG. 7, the system includes eight PCIe cards, each containing a pair of computing chips as described previously in FIG. 6. The PCIe cards are organized into two vertical columns, each column corresponding to a 4-card board or subsystem. Within each column, all PCIe cards are connected to a host CPU via a PCIe switch, using their respective PCIe interfaces. The PCIe switch provides high-bandwidth communication between the host and each primary chip on the PCIe cards, supporting data transfer, instruction dispatch, and control signaling.

In this configuration, each PCIe card operates with a primary chip and a secondary chip as described in FIG. 6. The primary chip of each card connects to the host system through the PCIe switch and orchestrates instruction scheduling for its paired secondary chip. The primary and secondary chips are connected via internal Ethernet links, with each chip's Ethernet interface logically divided into multiple channels to support point-to-point inter-chip and inter-card communication.

To enable communication between the two columns of PCIe cards, a backplane or physical high-speed cable is used to link the secondary chips across the two boards. Specifically, the secondary chips in each column are connected to the inter-board backplane via their second Ethernet channel. This connection enables data and instruction exchange across cards and columns, facilitating distributed execution of neural network tasks across the full eight-card system.

Each host in FIG. 7 manages four PCIe cards in its local board, forming a 4-card node. In some embodiments, the two hosts (e.g., two CPUs) may be connected to each other via a direct host-to-host or CPU-to-CPU link, such as NVLink, Infinity Fabric, or another high-bandwidth interconnect. Alternatively, the host-to-host communication may be mediated through a switching fabric or cluster manager, depending on the system topology. The inter-host connection allows the full 8-card system to function as a unified, high-throughput compute cluster.

This architecture demonstrates how the modular PCIe card design can be scaled to meet the computational demands of large-scale AI workloads. The system provides distributed compute across sixteen chips (eight cards×two chips per card), with coordinated scheduling, memory access, and instruction dispatch. By combining intra-card, intra-board, and inter-board communication pathways, the design achieves both parallelism and flexibility, allowing it to support deep learning training, inference, or hybrid AI pipelines at scale.

This architecture is particularly well-suited for large-scale artificial intelligence workloads, such as training deep neural networks or executing high-throughput inference tasks. For example, in transformer-based model training (e.g., BERT, GPT, or ViT), the system can parallelize computation across chips and cards at the layer level, sequence level, or batch level, enabling significant acceleration of training throughput while maintaining fine-grained control over memory usage and dataflow. The hierarchical scheduling mechanism—spanning chip, core, and PE levels—further supports dynamic load balancing and efficient use of compute resources across distributed pipelines.

In inference scenarios, the same system can be repurposed to serve multiple AI models simultaneously, with different chips or cards allocated to different models or workloads. The inter-card communication channels and flexible Ethernet-based interconnects allow real-time data routing, model handoff, and failover, making the system resilient and adaptable in production environments.

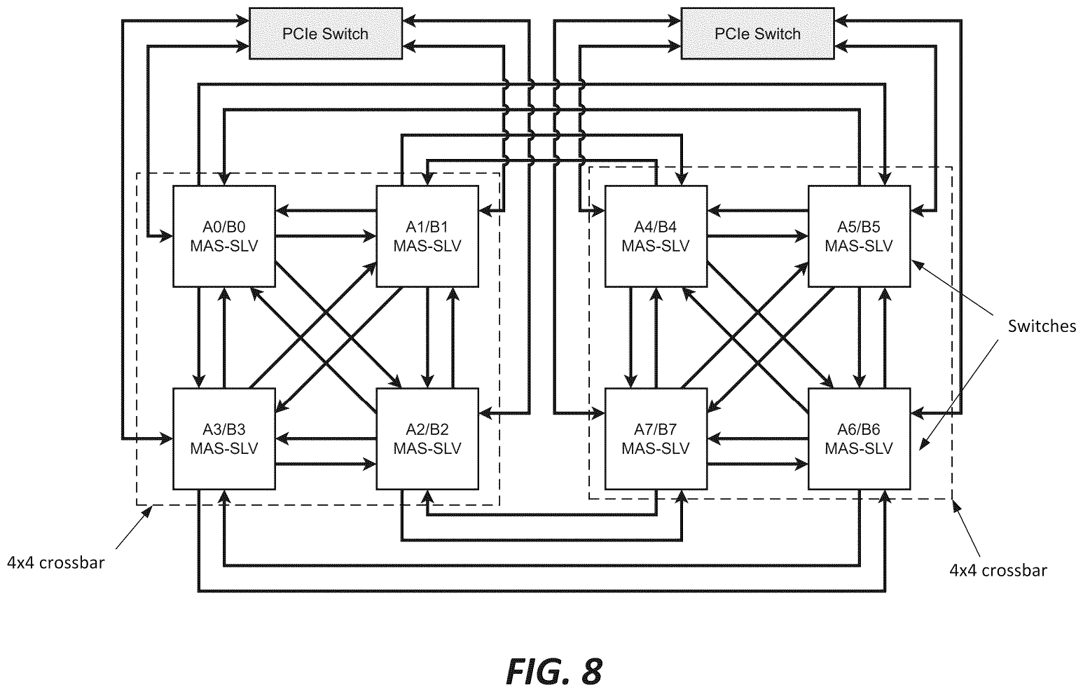

FIG. 8 illustrate an exemplary backplane architecture in the multi-card system of FIG. 7, in accordance with various embodiments. The backplane in FIG. 8 is designed to support high-bandwidth, low-latency communication among multiple PCIe cards deployed across different host systems. It enables efficient data and instruction exchange across the secondary chips of the PCIe cards and facilitates interconnection between distinct compute boards and their associated host devices.

In the illustrated embodiment, the backplane architecture includes two crossbar switching units—each implemented as a 4-by-4 crossbar. Each 4-by-4 crossbar is composed of four independent 4×4 switches, where each switch provides four input ports and four output ports. These ports support full-duplex, point-to-point communication paths among the connected devices, allowing any input to be dynamically routed to any output within the switch fabric. In FIG. 8, each switch is labeled with “A/B MAS-SLV”, representing two chips (A and B, acting as a master/primary chip and a slave/secondary chip) are connected through the switch.

The two crossbars are internally interconnected through their constituent switches, forming a unified switching fabric that allows communication not only within a single crossbar but also across the two crossbars. This crossbar interconnect enables PCIe cards connected to different host systems to exchange data or instructions through the backplane, thereby supporting distributed AI workloads that span multiple boards or system domains.

Each crossbar is further connected to one of the PCIe switches in the host systems described in FIG. 7. These connections allow the backplane to serve as a bridge for routing packets between the PCIe cards managed by one host and those managed by another. The architecture ensures that the secondary chips—connected to the backplane via their Ethernet interfaces—can directly communicate with secondary chips on other cards, regardless of which host they are physically attached to.

This backplane design supports scalable, non-blocking communication and maintains high aggregate bandwidth, making it well-suited for high-performance AI computation where multiple accelerator cards need to operate in close coordination. The modular nature of the switch fabric allows the system to scale to larger deployments by extending the number of switches or layering additional crossbar stages, depending on the bandwidth and system size requirements.

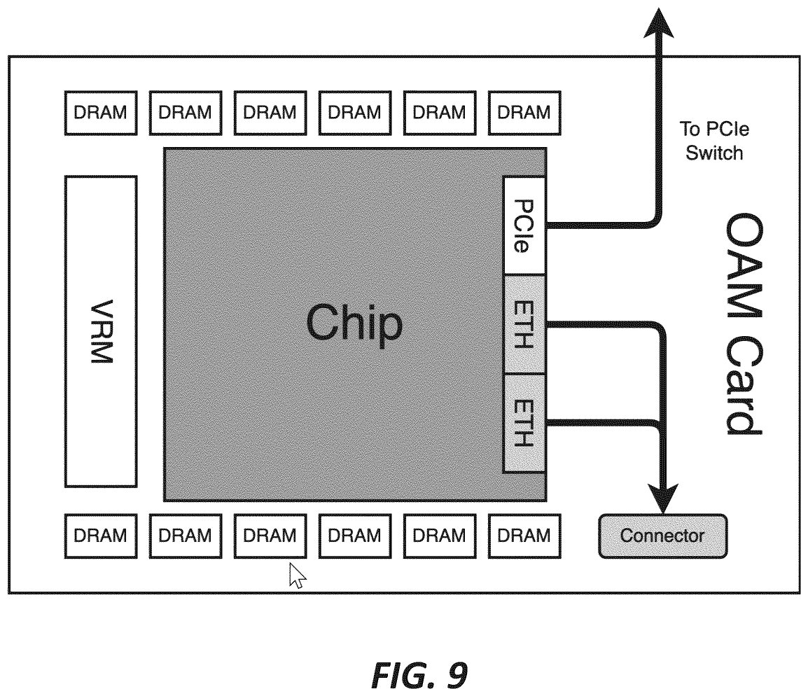

FIG. 9 illustrate an exemplary Open Compute Project (OCP) Accelerator Module (OAM) card hosting the chip for accelerating neural network computation, in accordance with various embodiments. Unlike the PCIe card design described in FIG. 6, which includes a pair of chips (i.e., a primary chip and a secondary chip) per card, the OAM card design shown in FIG. 9 packages a single chip—such as the chip architecture described in FIG. 1—per OAM card. This approach provides a more modular and scalable form factor suitable for large-scale deployments in datacenter environments.

As illustrated, each OAM card includes one instance of the accelerator chip, a local voltage regulation module (VRM) for power delivery, a set of DRAM modules for memory access, a PCIe port, and a plurality of Ethernet channels. The PCIe port of each OAM card is connected to a PCIe switch, which in turn is connected to a host processor or CPU. This configuration allows the host to manage and dispatch tasks to each individual OAM card directly, enabling parallel operation of many accelerators with shared or distributed workloads.

In addition to host connectivity, each OAM card includes multiple Ethernet channels that allow it to communicate with other OAM cards in the system. These high-speed Ethernet links can be used for inter-card data exchange, workload partitioning, and distributed training or inference coordination across cards. The use of Ethernet-based interconnects provides flexibility in topology design and supports scalable bandwidth for peer-to-peer communication.

One of the key benefits of the OAM-based implementation is the direct-plug form factor. Unlike PCIe cards—which must be installed into discrete PCIe slots on the motherboard, and are often limited in number due to physical space, lane availability, or thermal constraints—OAM cards are designed to be plugged directly into dedicated OAM sockets on the motherboard or a carrier board. These sockets can be arranged more densely and are optimized for power, cooling, and mechanical integration at the system level.

As a result, OAM-based systems can support a higher density of accelerator modules per system, without being limited by the number of available PCIe slots. This allows datacenter operators to deploy many more compute units within a single chassis, increasing overall AI processing capability while maintaining thermal and power efficiency. The modularity and direct connection of OAM cards also simplify system design, board layout, and high-speed signal routing, especially in environments where maximizing compute-per-rack is a key consideration.

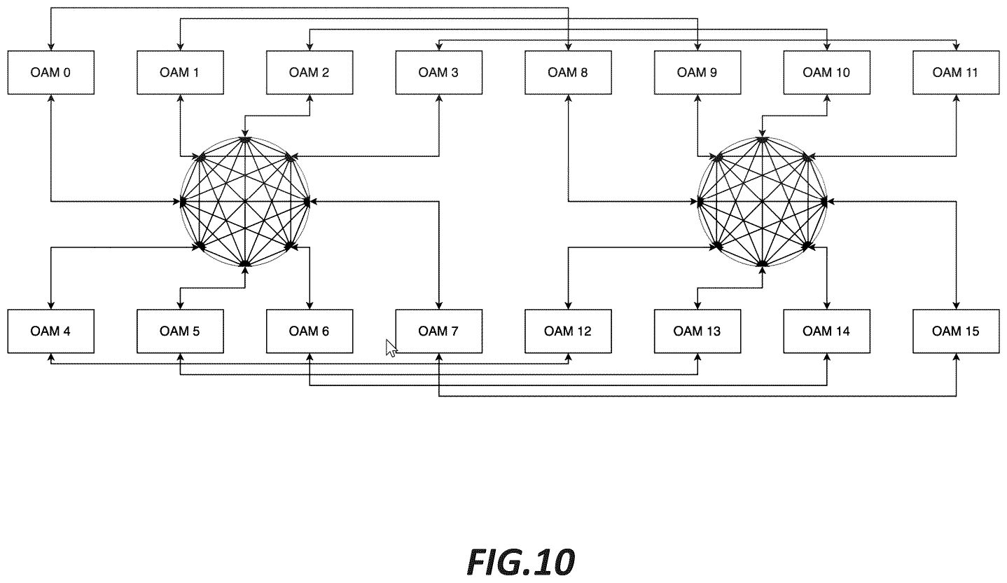

FIG. 10 illustrate an exemplary multi-card system with multiple OAM cards hosting the chips for accelerating neural network computation, in accordance with various embodiments. The system in FIG. 10 demonstrates how a set of OAM cards—each packaging a single chip as described in FIG. 1—can be interconnected to form a scalable and high-bandwidth compute cluster suitable for advanced AI workloads.

As shown in FIG. 10, a total of sixteen OAM cards are organized into two groups of eight OAM cards each. Each OAM card includes its own PCIe port and a plurality of Ethernet channels, as described in FIG. 9. Within each group of eight OAM cards, all cards are connected to one another through a 4×4 crossbar switch, using their high-speed Ethernet channels. These internal connections provide full-mesh or near-full-mesh communication paths within each group, enabling low-latency data and instruction exchange between all OAM cards in the same group.

In addition to intra-group connectivity, each OAM card in the first group is connected directly to a corresponding OAM card in the second group via dedicated one-to-one Ethernet links. These eight inter-group links form eight card pairs, each with a private communication channel between an OAM card in group one and its counterpart in group two. As a result, each OAM card in the system maintains direct communication with up to eight other cards—seven within its own group via the crossbar and one in the opposite group via the inter-group link.

This hybrid connection topology—combining crossbar-based intra-group networking and direct inter-group links—offers both high bandwidth and predictable latency, making it particularly suitable for deep learning workloads that rely on tightly coupled parallel computation. The distributed structure also reduces communication bottlenecks compared to traditional bus-based topologies or single-root switched fabrics.

Importantly, the architecture shown in FIG. 10 is highly scalable. Additional OAM cards can be integrated into the system by expanding the number of groups and deploying additional 4×4 crossbars to maintain efficient intra-group communication. Likewise, inter-group connectivity can be extended by introducing further direct links between new card pairs or additional interconnect stages. This modular approach allows for flexible system growth while preserving balanced communication paths and minimizing wiring complexity.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

What is claimed is:

1. A semiconductor device, comprising:
a plurality of cores connected through a ring-shape network-on-chip (NoC),
each of the plurality of cores comprising a plurality of processing entities (PEs), wherein the plurality of PEs are connected through a 2D mesh network, and
each of the plurality of PEs comprising (1) a plurality of computing engines, (2) a PE-level software-based instruction scheduler, and (3) a PE-level hardware-based instruction scheduler, wherein,
the PE-level software-based instruction scheduler is configured to compile incoming instructions and make run-time scheduling decisions for the plurality of computing engines based on the compiled instructions, and
the PE-level hardware-based instruction scheduler is configured to execute pre-compiled instructions to directly activate one or more of the plurality of computing engines.

2. The semiconductor device of claim 1, wherein the ring-shape NoC is coupled to a chip-level software-based instruction scheduler and a chip-level hardware-based instruction scheduler,
wherein the chip-level software-based instruction scheduler is configured to compile incoming instructions and generate scheduled tasks for the plurality of cores, and
the chip-level hardware-based instruction scheduler is configured to store pre-compiled instructions for activating chip-level hardware components.

3. The semiconductor device of claim 2, wherein the 2D mesh network is connected to a core-level software-based instruction scheduler and a core-level hardware-based instruction scheduler,
wherein the core-level software-based instruction scheduler is configured to compile incoming instructions and generate scheduled tasks for the plurality of PEs, and
the core-level hardware-based instruction scheduler is configured to store pre-compiled instructions for activating core-level hardware components.

4. The semiconductor device of claim 1, wherein the PE-level software-based instruction scheduler comprises a processor to compile and incoming instructions and execute the compiled instructions to generate the run-time scheduling decisions.

5. The semiconductor device of claim 1, wherein the PE-level hardware-based instruction scheduler is configured to activate the one or more of the plurality of computing engines to execute pre-defined computation logics.

6. The semiconductor device of claim 1, wherein the PE-level software-based instruction scheduler is assigned with a high priority than the PE-level hardware-based instruction scheduler due to run-time flexibility.

7. The semiconductor device of claim 1, wherein the PE-level software-based instruction scheduler sends instructions to the PE-level hardware-based instruction scheduler, for activating the one or more of the plurality of computing engines.

8. The semiconductor device of claim 1, wherein the PE-level hardware-based instruction scheduler is faster than the PE-level software-based instruction scheduler at activating the plurality of computing engines.

9. The semiconductor device of claim 1, wherein:
each of the plurality of cores is coupled to a cache and a double data rate memory (DDR), the cache is dedicated to the core, and the DDR is connected to a neighboring DDR of a neighboring core through the ring-shape NoC.

10. The semiconductor device of claim 1, wherein:
the plurality of PEs within each core are connected as the 2D mesh network through a plurality of routers, each PE being connected to one of the plurality of routers.

11. The semiconductor device of claim 1, wherein:
the plurality of PEs in a first core are connected to the plurality of PEs in a second core through routers.

12. The semiconductor device of claim 11, wherein the first core and the second core are neighboring cores.

13. The semiconductor device of claim 1, wherein the plurality of cores are distributed among a plurality of dies using a chiplet-based architecture.

14. The semiconductor device of claim 13, wherein the plurality of cores comprise four cores, and the plurality of dies comprise two dies, and the two dies are connected through a Universal Chiplet Interconnect Express (UCIe) interface.

15. The semiconductor device of claim 13, wherein the plurality of cores comprise four cores, and the plurality of dies comprise four dies, the four dies are organized as a two-by-two configuration, and each of the four dies is connected to two neighboring dies through respective UCIe interfaces.

16. The semiconductor device of claim 1, wherein each of the plurality of PEs further comprises an SRAM, the SRAM comprising a plurality of ports respectively connected to the plurality of computing engines in the PE.

17. The semiconductor device of claim 1, wherein each of the plurality of cores further comprises an instruction distribution unit (IDU) configured to fetch instructions from a DDR to which the core is connected.

18. The semiconductor device of claim 17, wherein the IDU is configured by a core-level software-based instruction scheduler of the core to start or pause the fetching of the instructions from the DDR to which the core is connected.

19. The semiconductor device of claim 1, wherein each of the plurality of PEs further comprise a data switch, wherein the data switch is configured to (1) receive data and move the data into an SRAM of the PE and (2) convert data format between high-precision and low-precision presentations.

20. The semiconductor device of claim 1, wherein the plurality of computing engines comprise a first engine configured for execute tensor computations, a second engine configured to perform vector operations, a third engine configured to perform tensor transposition, and a fourth engine configured to perform tensor sparsification and de-sparsification.
